(19) United States
(12) Patent Application Publication
(10) Pub. No.: US 2025/0316426 A1
(43) Pub. Date: Oct. 9, 2025

(54) BACKLIT KEYBOARD DEVICE

(71) Applicant: SUNREX TECHNOLOGY CORP, Taichung City (TW)

(72) Inventors: Shih-Pin LIN, Taichung City (TW); Pei-Sin LIN, Taichung City (TW); Hsing-Kuang CHEN, Taichung City (TW)

(73) Assignee: SUNREX TECHNOLOGY CORP, Taichung City (TW)

(21) Appl. No.: 18/887,356

(22) Filed: Sep. 17, 2024

(30) Foreign Application Priority Data
Apr. 8, 2024 (TW) 113112995

(51) Int. Cl. H01H 13/10; H01H 13/83

(52) U.S. Cl. CPC H01H 13/10; H01H 13/83

(57) ABSTRACT

A backlit keyboard device includes a light-emitting unit, and a thin-film circuit unit. The light-emitting unit includes a light-emitting member. The thin-film circuit unit includes a substrate, a bottom circuit layer, a spacer layer, a securing adhesive layer, a top circuit layer, and a resistor unit disposed between the securing adhesive layer and the top circuit layer. The spacer layer, the securing adhesive layer and the top circuit layer cooperatively define an accommodation space. The light-emitting member is disposed in the accommodation space and is electrically connected to the bottom circuit layer.

### CROSS-REFERENCE TO RELATED APPLICATION

This application claims priority to Taiwanese Invention Patent Application No. 113112995, filed on Apr. 8, 2024, and incorporated by reference herein in its entirety.

### FIELD

The disclosure relates to a computer keyboard device, and more particularly to a backlit keyboard device.

### BACKGROUND

Referring to FIG. 5, a conventional keyboard device as disclosed in Taiwan Utility Model Patent No. M403696 includes a switch module 43, a comparator 5, an exchange unit 6, and a processing module 82. The switch module 4 includes a plurality of strobe lines 41 that are configured to respectively receive a plurality of strobe signals, a plurality of sen6se lines 42, and a plurality of switch units 43. Each of the switch units 43 has a switch 431 and a resistor 432 connected in series between a corresponding one of the strobe lines 41 and a corresponding one of the sense lines 42. The comparator 5 includes a first input end, a second input end for receiving a reference signal, and an output end for outputting a comparison signal. The comparator 5 is configured for comparing a signal received at an input end thereof with a reference signal for generating the comparison signal. The exchange unit 6 is electrically connected to the sense lines 42 and the comparator 5, and is operable in response to a control input for making and breaking electrical connection between each of the sense lines 42 and the input end of the comparator 5. The processing module 82 is configured to set the strobe signals, the reference signal and a control input such that the comparison signal is able to indicate whether at least one switch 431 from all of the switch units 43 is in a conducting state, whether at least one switch 431 from the plurality of switch units 43 is in the conducting state, or whether one switch 431 is in the conducting state. This prevents keyboard ghosting.

Due to advancement in technology, consumers expect to have backlighting on keyboard devices in order to effectively type in dimly lit environments. However, if a backlight module were to be installed beneath an anti-ghosting circuit unit of the above conventional keyboard that has anti-ghosting capabilities, the thickness of the conventional keyboard device will be increased by a large amount.

### SUMMARY

Therefore, an object of the disclosure is to provide a backlit keyboard device that can alleviate at least one of the drawbacks of the prior art.

According to the disclosure, the backlit keyboard device includes a light-emitting unit, and a thin-film circuit unit. The light-emitting unit includes at least one light-emitting member. The thin-film circuit unit includes a substrate, a bottom circuit layer that is disposed on a top surface of the substrate, a spacer layer that is disposed on a top surface of the bottom circuit layer, a securing adhesive layer that is disposed on a top surface of the spacer layer, a top circuit layer that is disposed on a top surface of the securing adhesive layer, and a resistor unit disposed between the securing adhesive layer and the top circuit layer. The spacer layer, the securing adhesive layer and the top circuit layer cooperatively define an accommodation space on the bottom circuit layer. The at least one light-emitting member is disposed in the accommodation space and electrically connected to the bottom circuit layer.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is an exploded perspective view illustrating an embodiment of a backlit keyboard device according to the present disclosure.

FIG. 2 is a fragmentary cross-sectional view illustrating the embodiment.

FIG. 3 is a fragmentary exploded schematic perspective view of the embodiment taken from a portion of FIG. 1.

FIG. 4 is another fragmentary exploded schematic perspective view of the embodiment taken from a different portion of FIG. 1.

FIG. 5 is a circuit block diagram illustrating a conventional keyboard device disclosed in Taiwan Utility Model Patent No. M403696.

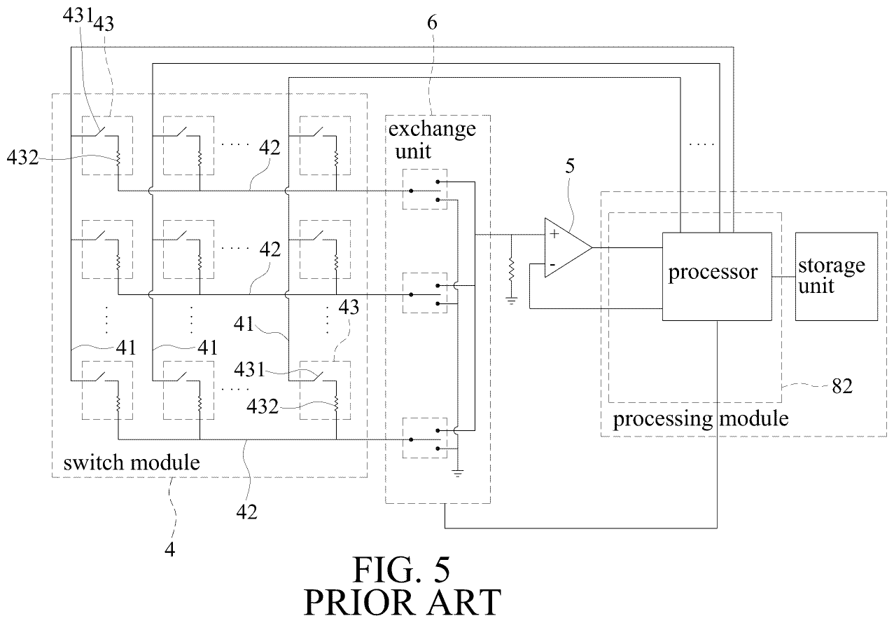

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

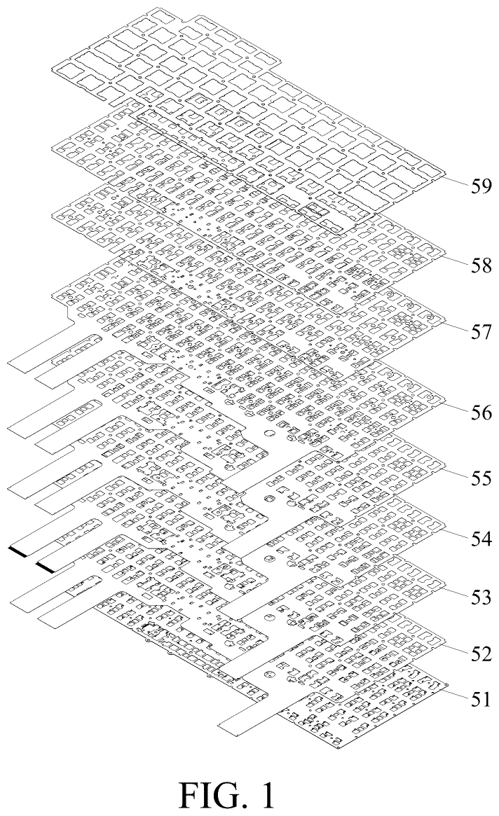

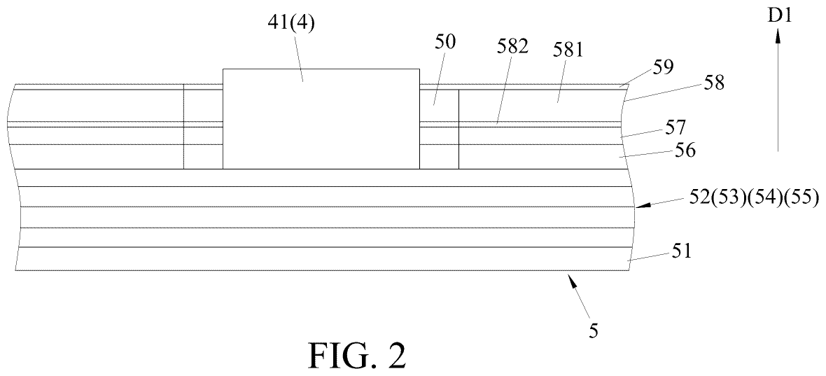

Referring to FIGS. 1 and 2, an embodiment of a backlit keyboard device according to the present disclosure includes at least one light-emitting unit 4, and a thin-film circuit unit 5. The light-emitting unit 4 includes at least one light-emitting member 41 and a drive circuit 42. In this embodiment, there are a plurality of light-emitting members 41 and they are implemented as Mini LEDs. For the sake of brevity, only two light-emitting members 41 will be described as an example in the following.

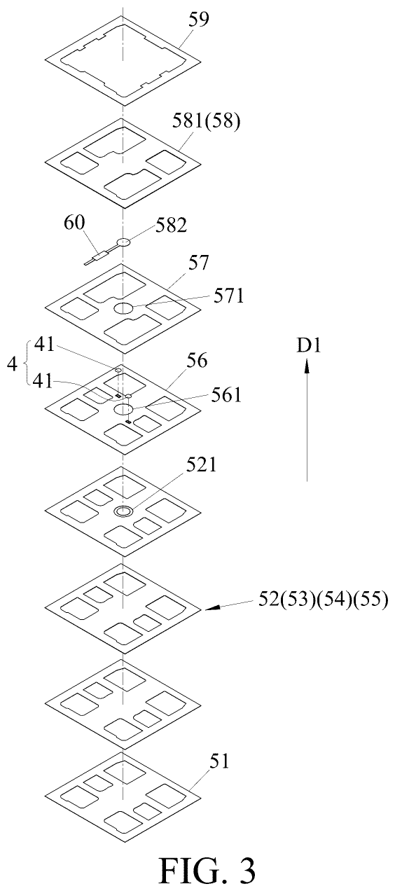

The thin-film circuit unit 5 is stacked in an top-bottom direction (D1), and includes a substrate 51, a bottom circuit layer 52 that is disposed on a top surface of the substrate 51, a spacer layer 56 that is disposed on a top surface of the bottom circuit layer 52, a securing adhesive layer 57 that is disposed on a top surface of the spacer layer 56, a top circuit layer 58 that is disposed on a top surface of the securing adhesive layer 57, a plurality of resistor units 60 (only one is shown in FIG. 3) disposed between the securing adhesive layer 57 and said top circuit layer 58, and an anisotropic conductive film 61. The spacer layer 56, the securing adhesive layer 57, and the top circuit layer 58 cooperatively define an accommodation space 50 above the bottom circuit layer 52. The light-emitting members 41 are disposed in the accommodation space 50 above the top surface of the bottom circuit layer 52. A light blocking layer 59 may be disposed on a top surface of the top circuit layer 58. As shown in FIG. 2, the accommodation space 50 may extend upward through the light blocking layer 59, and the light emitting member 41 may protrude upwardly from the light blocking layer 59.

The bottom circuit layer 52 may be a double-sided flexible printed circuit board. The light-emitting members 41 are electrically connected to a bottom circuitry (not shown) which may be formed at a bottom or top surface of the bottom circuit layer 52. In some embodiments, the bottom circuit layer 52 may include a lower copper track layer 53 that is disposed on a top surface of the substrate 51, an insulating layer 54 that is disposed on a top surface of the lower copper track layer 53, and an upper copper track layer 55 that is disposed on a top surface of the insulating layer 54. The light-emitting members 41 are proximate to a bottom contact 521 of the bottom circuitry and are respectively located at two opposite sides of the bottom contact 521. With this design, a drive circuit need not be mounted beneath the substrate 51 which thereby saves space and decreases the overall thickness of the backlit keyboard device. Furthermore, it should be noted that the bottom circuit 52, the top circuit layer 58, and the resistor units 60 cooperatively form an anti-ghosting circuit (not shown) so that the backlit keyboard device has anti-ghosting functionality. The actual implementation of the anti-ghosting circuit may be the same as that described hereinbefore in the background; however, the anti-ghosting circuit is not a technical feature of the present disclosure, and is therefore omitted in the following.

Referring to FIG. 3, the top circuit layer 58 has a thin film 581 with a bottom surface, and a top circuitry 582 that is disposed on the bottom surface of the thin film 581. In this embodiment, each resistor unit 60 has at least one printed carbon resistor, and is disposed on the bottom surface of the thin film 581 together with the top circuitry 582. It should be noted that FIG. 3 is taken from a section of FIG. 1 to explain the relation between the resistor unit 60, the top circuit layer 58, the securing adhesive layer 57, and the spacer layer 56. FIG. 3 is a schematic diagram showing only one of the resistor units 60 for the sake of clarity, and the disclosure is not limited to that.

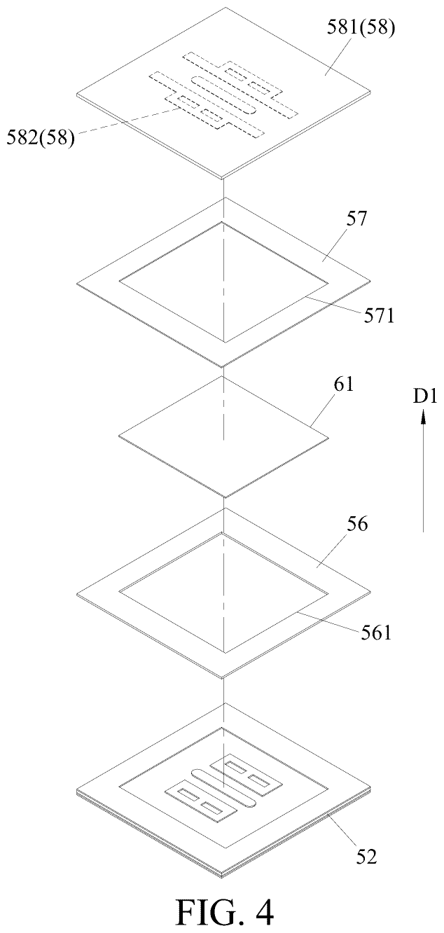

In this embodiment, there may be a plurality of anisotropic conductive films 61; however, for the sake of brevity and clarity of explanation, only one anisotropic conductive film 61 is described as an example in the following. Referring to FIG. 4, the spacer layer 56 has a plurality of first windows 561 (only one is shown) to receive the anisotropic conductive film 61. The securing adhesive layer 57 has a plurality of second windows 571 (only one is shown) to receive the anisotropic conductive film 61. The anisotropic conductive film 61 is allowed to extend into the corresponding first window 561 and the corresponding second window 571 for electrically connecting the top circuit layer 58 and the bottom circuit layer 52. It should be noted that FIG. 4 is a schematic diagram explaining the position of the anisotropic conductive film 61 relative to the bottom circuit layer 52, the spacer layer 56, the securing adhesive layer 57, and the top circuit layer 58. FIG. 4 is intended to merely show the location of the anisotropic conductive film 61 relative to the first window 561 and the second window 571.

The anisotropic conductive film 61 is disposed between the bottom circuit layer 55 and the top circuit layer 58, and is heated and pressed to be connected to the top circuitry 582 of the top circuit layer 58 in the top-bottom direction (D1). The bottom contact 521 of the bottom circuit layer 52 corresponds in position to the first window 561 of the spacer layer 56, the second window 571 of the securing adhesive layer 57, and a top contact (which will be described hereinafter) of the top circuitry 582 also corresponds in position to the first window 561 and the second window 571.

During practical use, the anisotropic conductive film 61 acts as the top contact of the top circuitry 582 of the top circuit layer 58. A corresponding switch is open when the anisotropic conductive film 61 is not pressed, and is closed when the anisotropic conductive film 61 is pressed by a user to electrically connect the bottom circuit layer 55 to the circuitry 582 of the top circuit layer 58. When the switch is closed, a corresponding key of the backlit keyboard device is determined to be pressed. In other words the anisotropic conductive layer 61 may be pressed by the user along the top-bottom direction (D1) through the first window 561 of the bottom circuit layer 56 and the second window 571 of the securing adhesive layer 57 to electrically connect the bottom circuit layer 55 to the top circuitry 582 of the top circuit layer 58, and thereby closing the switch of the backlit keyboard device.

Furthermore, because the resistor units 60 and the top circuitry 582 are disposed and laid out on a bottom side of the thin film 581 of the top circuit layer 58, the backlit keyboard device may be made thinner when a carbon film resistor is used. Additionally the printed carbon resistor is lighter and more flexible which prevents breaking and falling off, and provides cost savings.

Additionally, it should be noted that the present embodiment may be combined with the prior art technical features described hereinbefore in the background of the present disclosure to have an anti-ghosting function, but while still maintaining a thin form. For example, the thin-film circuit unit 5 of the present embodiment may have a plurality of key switches (not shown) each of which is connected in series to the corresponding resistor unit 60. Each resistor unit 60 cooperates with the corresponding key switch to form a switch unit and is used to determine the conduction conditions of the corresponding switch unit and prevent ghosting.

By virtue of the combination of the bottom circuit layer 52, the top circuit layer 58, and the resistor units 60 providing an anti-ghosting circuit and by virtue of the top circuit layer 58, the securing adhesive layer 57, and the spacer layer 56 cooperatively defining the accommodation space 50 to dispose the light-emitting member, no backlit module is needed beneath the anti-ghosting circuit, and the backlit keyboard device of the present disclosure may have a decreased thickness while still having anti-ghosting functionality.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A backlit keyboard device comprising:
a light-emitting unit including at least one light-emitting member; and
a thin-film circuit unit including
a substrate,
a bottom circuit layer that is disposed on a top surface of said substrate,
a spacer layer that is disposed on a top surface of said bottom circuit layer,
a securing adhesive layer that is disposed on a top surface of said spacer layer,
a top circuit layer that is disposed on a top surface of said securing adhesive layer, and
a resistor unit disposed between said securing adhesive layer and said top circuit layer;
wherein said spacer layer, said securing adhesive layer, and said top circuit layer cooperatively define an accommodation space on said bottom circuit layer, said at least one light-emitting member being disposed in said accommodation space and electrically connected to said bottom circuit layer.

2. The backlit keyboard device as claimed in claim 1, wherein said resistor unit has at least one printed carbon resistor.

3. The backlit keyboard device as claimed in claim 1, wherein:
said thin-film circuit unit further includes an anisotropic conductive film formed on said top circuit layer, said spacer layer having a first window, said securing adhesive layer having a second window; and
said anisotropic conductive film is allowed to extend into said first window and said second window for electrically connecting with said bottom circuit layer.

4. The backlit keyboard device as claimed in claim 1, wherein:
said top circuit layer having a thin film with a bottom surface, and a top circuitry that is disposed on said bottom surface of said thin film and covered by said securing adhesive film; and
said resistor unit is disposed on said bottom surface of said thin film together with said top circuitry.

5. The backlit keyboard device as claimed in claim 1, wherein said bottom circuit layer has a bottom contact, and said at least one light-emitting member is proximate to said bottom contact.

6. The backlit keyboard device as claimed in claim 5, wherein said thin-film circuit unit further has a light blocking layer disposed on said top circuit layer, said accommodation space extending through said light blocking layer, said at least one light-emitting member protruding upward through said light blocking layer.
